(19) United States
(12) Patent Application Publication
(10) Pub. No.: US 2009/0087519 A1
(43) Pub. Date: Apr. 2, 2009

(54) Nutrition Products

(76) Inventors: Danielle Christa Hundscheid, Vlaardingen (NL); Rafi Nachum, Haifa (IL); David Pupko, Safad (IL); Eelke Garben ter Schure, Vlaardingen (NL); Ronit Haya Sklar, Arad (IL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/920,321

(22) PCT Filed: Apr. 12, 2006
(86) PCT No.: PCT/EP2006/003552

§ 371 Date: Nov. 13, 2007

(30) Foreign Application Priority Data
May 19, 2005 (EP) 05076176.6

(51) Int. Cl. A23L 1/304; A23L 1/00; A23P 1/12

(52) U.S. Cl. 426/74; 426/89; 426/283

(57) ABSTRACT

The present invention provides a nutrition product comprising a first region comprising at least 10% by weight of said first region of one or more oxidisable materials containing monounsaturated and/or polyunsaturated fatty acids, and a second region comprising 0.002% to 1.0% by weight of said second region of one or more oxidising materials selected from chromium, manganese, iron, cobalt, nickel, copper, selenium and zinc and wherein the oxidisable materials and the oxidising materials in the nutrition product are comprised in different regions of the product. The nutrition products have good organoleptic properties and exhibit good stability, both physical and chemical, upon storage. They also provide a convenient way of incorporating the above-mentioned nutrients into the diet.

### FIELD OF THE INVENTION

The present invention relates to nutrition products that comprise monounsaturated and/or polyunsaturated fatty acids and oxidising metals (and/or their compounds) in different regions of the product. The products exhibit good physical and/or chemical stability.

### BACKGROUND OF THE INVENTION

The importance of good nutrition and the benefits therefrom upon health and development, especially in children, is already well recognised. In recent years many different nutrients and micronutrients have received attention in connection with various health benefits and the problems associated with a dietary deficiency of these nutrients and micronutrients has been the subject of extensive research.

It is also becoming increasingly recognised that the development, both physically and psychologically, of children (including young adults who are still in the growth phase) can be seriously hindered by a diet which does not contain sufficient amounts of various nutrients and micronutrients.

Two particular groups of micronutrients which are recognised as beneficial in the diet are polyunsaturated fatty acids (hereinafter referred to as PUFAs) and metals (including their compounds). In particular the alkaline metals, alkaline earth metals and transition metals are recognised as being beneficial in the diet.

Certain omega-3 Polyunsaturated Fatty Acids which are one type of polyunsaturated fatty acids have been linked with cognitive performance. Studies have shown that infants who are fed formula milk supplemented with docosahexaenoic acid (DHA), α-linolenic acid (ALA) and arachidonic acid (AA), and those who are breast-fed demonstrate better visual acuity and cognitive performance, including problem solving (Uauy et al, 2001, Essential fatty acids in somatic growth and brain development. Nutrition and fitness: Diet, genes, physical activity and health. NY: Karger. pp. 134-160). PUFAs are also recognised to help in many other health benefits in the body, such as heart health benefits. These types of fatty acids cannot be synthesized by the body and so good dietary intake is important.

Transition metal ions are also recognised as being valuable micronutrients.

Iron is thought to be an important nutrient for the cognitive performance and development of children because the areas of the brain that are sensitive to iron deficiency (such as the cortex, frontal lobes and hippocampus) are the areas responsible for higher level cognitive functions such as executive functions and memory (Beard, 1995, American Journal of Nutrition, 62, 709-710). Furthermore, iron is known to be vital for forming haemaglobin which is needed for the transport of oxygen around the body and without sufficient dietary amounts of iron a subject may become anaemic or develop other health problems.

Zinc is another transition metal which may have direct effects upon cognitive performance. It may also have an indirect effect through the enhancement of the efficacy of iron (Black & Miguel, 2001, The emerging roles of zinc in human nutrition, development and infectious disease, part 1, Nutrition Today, 36, 281-290). Zinc is important for cognitive performance and development of children because it is important for myelination and release of the neurotransmitters GABA and glutamate that are key modulators of neuronal excitability (Bhatnagar & Taneja, 2001, Zinc & cognitive development. British Journal of Nutrition, 85, S139-S145). Intervention studies show that 20 mg/day zinc plus other micronutrients has a positive effect on reasoning and visual recognition in Chinese and Mexican American school-aged children (Penland, 2000, Behavioural data and methodological issues in studies of zinc nutrition in humans, Journal of Nutrition, 130, 361S-364S).

Selenium has been implicated in the protection of body tissues against oxidative stress, maintenance of defences against infection and modulation of growth and development.

Copper is known to be essential in the body as it is needed to help biochemical reactions occur in the body. It is also involved in the absorption, storage and metabolism of iron.

However, although it is known to be desirable to incorporate different nutrients and/or micronutrients into nutrition products, such as foods, beverages and food supplements, the products themselves will often suffer from problems caused by the presence of these different nutrients and/or micronutrients as they are often at least to some extent incompatible.

It is well known to include sources of polyunsaturated fatty acids in nutrition products. U.S. Pat. No. 6,444,700 discloses nutritional compositions intended to address the effects of stress, which compositions may comprise PUFAs. EP-A-768-043 discloses diabetic nutritional products that may comprise fish oil (which contains PUFAs) and also individual PUFAs such as docosahexaenoic acid or eicosapentaenoic acid. U.S. Pat. No. 6,248,375 discloses solid matrix nutritionals designed for people with diabetes. The compositions may comprise marine oils or olive oils. U.S. Pat. No. 6,048,557 discloses a process for the preparation of a PUFA containing composition wherein a PUFA containing lipid is adsorbed onto a solid carrier. The product is said to be useful for the formulation of infant milk formulas. U.S. Pat. No. 5,013,569 discloses encapsulated docosahexaeonic acid or eicosapentaenoic acid in infant milk formulas. WO 03/079818 discloses a bar product that is intended to enhance mental alertness and which may comprise PUFAs. U.S. Pat. No. 6,140,304 discloses nutritional and pharmaceutical compositions for the reduction of hyperinsulinemia. These compositions may comprise sources of PUFAs. A ZONEPerfect® Nutrition bar, Chocolate Mint Flavour, available for sale in the United States at least as of Jul. 28, 2004, discloses that it contains 3 mg of “omega 3” and lists fish oil amongst its ingredients.

However, problems associated with the inclusion of sources of polyunsaturated fatty acids in nutrition products, particularly their tendency to oxidise and/or to develop unpleasant or off-flavours (which often results from oxidation of the oil) are also well known and efforts have been made to try to address these problems.

U.S. Pat. No. 4,775,749 and U.S. Pat. No. 4,777,162 disclose compounds of eicosapentaenoic acid and cyclodextrin which are said to be stable and have reduced malodour and which are disclosed for use in food products. EP-A-424-578 discloses a dry solid composition comprising lipids, such as fish oils, protected in sodium caseinate. The products are said to exhibit considerable stability to oxidation. EP-A-425-213 discloses a dry solid composition similar to that of EP-A-424-578 but further comprising starch. U.S. Pat. No. 6,444,242 discloses micro-encapsulated oil and fat products which may comprise PUFAs and which are said to be stable for at least one year. U.S. Pat. No. 4,913,921 discloses food products, such as salad dressings which comprise fish oil and a fish-stabilising antioxidant to prevent the development of malodours. FR-A-2,757,055 discloses a fluid powder comprising microcapsules consisting of fish oil reach in polyunsaturated fatty acids which are fixed onto a solid matrix which is a colloid associated with one or more carbohydrates. WO 88/02221 recognises that docosahexaeonic acid or eicosapentaenoic acid are difficult in the oil phase to mix with water and discloses the preparation of a granulate comprising these oils to address this problem. Another approach which has been taken in the art is to try to stop the materials which cause oxidation asserting their action upon oxidation sensitive materials. To this end, the Wright Group of Crowley, La., USA offers the following edible wax-encapsulated minerals under the name SuperCoat™; WE101266 (iron), WE101265 (zinc), WE101270 (copper) and WE101267 (manganese).

Generally consumers find it convenient to have nutrition products which can be eaten as snack products. This provides several advantages such as they can be consumed anywhere, are convenient to eat and can be easily incorporated into the average daily diet.

Such snack products may be either savoury or sweet in flavour depending upon the type of product and the taste desired by the consumer.

GB2363049 is directed to a food which may be co-extruded. A lower water component may be cereal based and may be co-extruded around a higher water component which may be fish or meat based. Both the lower water component and the higher water component may be fortified to include vitamins, minerals and dietary fibre.

U.S. Pat. No. 6,001,400 discloses a bagel and high fat cream cheese product which may be co-extruded. The cream cheese may be mixed with heat stable ingredients such as pepper, dried onion, sausage or dried fish. Cereal shells are mentioned. The product is bite-sized.

U.S. Pat. No. 5,641,527 is directed to a process of making a filled bagel dough product. The bagel is described at one point as a shell. The filling may be a natural, artificial or imitation cream cheese.

U.S. Pat. No. 4,762,723 is directed to a method of extruding a cooking with a filling cream having a high sugar content. At one point, an external casing is said to form a tube about an internal filling.

Kemeny patent application publication US 2003/0087004 is directed to sweet and savoury ready to eat food bars. A bar containing oat bran, soy protein isolate and canola oil is disclosed. Sugar and sugar-substitutes, as well as unhealthy forms of fat are said to be limited to 10 wt %.

WO 94/28727 describes an apparatus and method for forming filled cereal pillows. The filling is selected from a group which can be fat based such as cheese, peanut butter or butter. The background section mentions a pillow fabricated from a puffed cereal dough with a fat based filling such as a cream based filling.

The fortification of such food products with selected nutrients and/or micronutrients provides the additional benefit of also giving nutritionally desirable products which have the aforementioned advantages for snack products.

Gaonkar US2004/0253347 mentions a multi-component food which may be a shell with a filling or spread such as cream cheese. The moisture barrier used in the food may comprise vitamins and minerals as well as oils such as olive oil.

U.S. Pat. No. 6,749,886 is directed to a confectionery bar providing a meal replacement which has a weight ratio of proteinaceous material and a carbohydrate material higher than 1. The bar may be fortified with minerals such as iron and zinc.

Funk et al. US published patent application 20040013771 is directed to a layered cereal bar. The binder used in the cereal layer(s) of the bar may be a complex carbohydrate binder which may comprise minerals such as iron and zinc.

Froseth et al. U.S. Pat. No. 6,592,915 is directed to a layered cereal bar. In one embodiment, the binder used in the cereal layer(s) of the bar may comprise minerals such as iron and zinc.

Prosise WO 01/78522 (Procter & Gamble) discloses nutritional foods said to have a balance of amino acids, fats and carbohydrates. Marine oils may be used in the compositions as may minerals such as iron and zinc.

However, generally the proposals given by the prior art are complicated and/or expensive or may limit formulation flexibility or make the product unattractive to the consumer either visually or in terms of the products organoleptic properties.

Therefore, there is a need to provide nutrition products, such as foods, beverages and food supplements which comprise beneficial nutrients and/or macronutrients in effective amounts but which do not suffer from unacceptable levels of instability. This instability may manifest itself as physical or chemical instability of either the product or the ingredients thereof.

There is also a need to provide nutrition products which provide beneficial nutrients and/or macronutrients in effective amounts and yet which exhibit good organoleptic properties as whilst consumers express a preference for snacks and other foods which are nutritionally beneficial, they show little inclination to sacrifice the organoleptic properties of their favourite foods or snacks in order to obtain nutrition benefits. This is particularly the case for children.

Therefore, it is important that nutrition products are palatable to consumers.

### SUMMARY OF THE INVENTION

Surprisingly the Applicants have found a simple and effective way of providing products that have a good nutritional profile but that exhibit good stability and organoleptic properties. If the oxidisable fatty acids and the materials which contribute towards their oxidation are kept out of physical contact with each other in the nutrition products then the expected stability problems do not occur or are significantly reduced.

Thus, according to a first aspect the present invention provides a nutrition product comprising;
a) a first region comprising at least 10% by weight of said first region of one or more oxidisable materials containing monounsaturated and/or polyunsaturated fatty acids, and
b) a second region comprising 0.002% to 1.0% by weight of said second region of one or more oxidising materials selected from chromium, manganese, iron, cobalt, nickel, copper, selenium and zinc
   and wherein the oxidisable materials and the oxidising materials in the nutrition product are comprised in different regions of the product.

Thus, according to a second aspect the present invention provides a process of making a nutrition product, by forming the nutrition product from;
I) a first region comprising at least 10% by weight of said first region of one or more oxidisable materials containing monounsaturated and/or polyunsaturated fatty acids, and
II) a second region comprising 0.002% to 1.0% by weight of said second region one or more oxidising materials selected from chromium; manganese, iron, cobalt, nickel, copper, selenium and zinc,
   and wherein the oxidisable materials and the oxidising materials in the nutrition product are comprised in different regions of the product.

The term “oxidising materials” as used herein means materials which can oxidise other materials. The term “oxidisable materials” as used herein means materials which can be oxidised by other materials.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Except in the operating and comparative examples, or where otherwise explicitly indicated, all numbers in this description indicating amounts of material or conditions of reaction, physical properties of materials and/or use are to be understood as modified by the word “about.” All amounts are by weight, based on the total weight of the relevant product, unless otherwise specified.

Unless stated otherwise or required by context, the terms “fat” and “oil” are used interchangeably herein.

As used herein, “sugar solids” refers to solids contributed by mono- and disaccharides.

RDA as referred to herein is the Recommended Dietary Allowances 10^{th} ed., 1989, published by the National Academy of Science, National Academy Press, Washington, D.C.

For a more complete explanation of the above and other features and advantages of the invention, reference should be made to the following description of the preferred embodiments. The preferred embodiments apply to all aspects of the invention and can be used as appropriate for each aspect unless the context requires otherwise.

### DETAILED DESCRIPTION OF THE INVENTION

### Format of the Nutrition Product

The nutrition products of the invention may be in any form comprising two or more regions wherein the oxidisable material is located in one region and the oxidising material is located in another region so that they do not substantially contact each other.

In preferred embodiments of the invention the nutrition products may comprise;
1) a shell containing a filling, for example, coextruded therewith, or
2) two or more individual layers with or without a filling therebetween, or
3) one or more layers with a topping or coating.

Preferably the nutrition products are snack food products, such as nutrition bars or expanded snack products having one of the above formats. A particularly preferred format of the nutrition product is a shell containing a filling.

The invention is further described below with particular reference to the format comprising a shell containing a filling or to containing layer(s) and coatings, fillings and/or toppings. However, the comments thereunder with respect to the type of ingredients and the amounts thereof are equally applicable to other forms of the nutrition products that have at least two regions.

It is especially preferred that the first region of the product is a filling, coating or topping. It is especially preferred that the second region of the product is a shell or layer(s). It is to be understood that the first and second regions of the product may be reversed so that the second region of the product is a filling, coating or topping and the first region of the product is a shell or layer(s).

It is preferred that the product comprises 20 to 80% wt of the first region, especially when it comprises the oxidisable material and 80 to 20% wt of the second region, especially when it comprises the oxidising material, based on the total weight of the product. It is most preferred that the product comprises 30 to 70% wt of the first region, and 70 to 30% wt of the second region, most preferably 40 to 60% wt of the first region and 60 to 40% wt of the second region. For some product formats it is preferred to have 45 to 55% wt of the first region, and 55 to 45% wt of the second region.

### Oxidisable Materials

The nutrition products of the invention comprise one or more oxidisable materials in a first region of the product and one or more oxidising materials in a different region so that oxidisable materials do not substantially contact the oxidising materials. Thus, the first region is substantially free from oxidising materials.

The oxidisable materials comprise monounsaturated fatty acids and/or polyunsaturated fatty acids. Any of the omega 3 and omega 6 fatty acids may be used according to the present invention.

It is preferred that the omega 3 and omega 6 fatty acids have a chain of C16 to C26, preferably C18 to C22. Chain lengths of C18, C20, C22, C24 and C26 are most preferred.

Where omega 3 and omega 6 fatty acids are used, they are preferable used in weight ratio of omega 3 to omega 6 of from 1:1 to 1:10, preferably 1:4 to 1:6.

The most preferred fatty acids according to the invention are; arachidonic acid, docosahexaenoic acid, eicosapentaenoic acid, lineoleic acid, linolenic acid (alpha linolenic acid) and gamma-linolenic acid.

The monounsaturated fatty acids and/or polyunsaturated fatty acids may be present as the acids themselves or monoglycerides, diglycerides or triglycerides and oils comprising them. Polyunsaturated acids are most preferred according the invention, especially those selected from omega 3 and omega 6 fatty acids.

It is preferred that the nutrition products are low in trans and saturated fat moieties.

Any suitable oils comprising the monounsaturated fatty acids and/or polyunsaturated fatty acids may be used. Among the oils may be included suitable vegetable oils, marine oils such as fish oils and fish liver oils and algae oils. Possible vegetable oil sources include olive oil, soybean oil, canola oil, high oleic sunflower seed oil, high oleic safflower oil, safflower oil, sunflower seed oil, flaxseed (linseed) oil, corn oil, palm, palm kernel, coconut, rapeseed, cottonseed oils, peanut oil, walnut oil, cashew nut oil, evening primrose oil, borage oil, and blackcurrant oil.

A blend of oils may be used. An especially preferred blend of oils is a blend of linseed oil and sunflower oil. The blend of oils may contain either synthetic antioxidants such as BHT and/or TBHQ or natural antioxidants such as mixed tocopherols, ascorbic acid and rosemary extract or a blend of the above.

It is preferred that in the nutrition product according to the invention the oxidisable materials are present in an amount of from 10 to 25% wt based on the total weight of the product. It is also preferred that in the nutrition product according to the invention the oxidisable materials are present in the first region of the product in an amount of from 20 to 50% based on the total weight of the first region, preferably 30 to 45% wt. The nutrition product preferably includes no greater than 10 wt % (on total fat) of trans- and saturated fatty acids. A region of the nutrition product preferably includes no greater than 20 wt % (on total fat) of trans- and saturated fatty acids.

### Oxidising Materials

The oxidising material in the nutrition product of the present invention is capable of altering the oxidation state of another material. It is preferred that the oxidising materials comprise metals capable of having two or more different oxidation states. Preferably the aforementioned metals are selected from transition metals. Most preferred oxidising materials are iron and zinc.

The oxidising materials may be added either as the materials themselves or as compounds or complexes thereof. Mixtures of the oxidising materials and their compounds or complexes thereof may also be used. A mixture of iron compounds with zinc compounds is especially preferred. Any suitable compound or complex may be used as desired. Suitable examples include manganese sulfate, ferric orthophosphate, iron fumarate, copper sulfate, zinc oxide, zinc sulphate.

It is especially preferred according to the invention that the oxidisable material is a mono or polyunsaturated fatty acid and the oxidising material is a transition metal.

It is also especially preferred according to the invention that the polyunsaturated fatty acid is selected from arachidonic acid, docosahexaenoic acid, eicosapentaenoic acid, lineoleic acid, linolenic acid (alpha linolenic acid) and gamma-linolenic acid and the transition metal is selected from iron and zinc.

A nutrition product according to any one of the preceding claims, wherein the oxidising materials are present in the product in an amount of from 0.001 to 0.5% wt based on the total weight of the product, preferably 0.01 to 0.3, such as 0.015 to 0.1% wt. This amount refers to the amount of the oxidisable material per se, e.g. iron or zinc, and not to the amount of the compound or complex comprising the same.

A nutrition product according to any one of the preceding claims, wherein the oxidising materials are present in the second region in an amount of 0.02 to 0.6, such as 0.03 to 0.2% wt based on the total weight of the second region, are particularly preferred.

### The Shell/Layer(s)

In one embodiment, the snack food comprises

an outer shell or one or more layers, especially a shell or layer(s) comprising one or more cereal ingredients.

The shell or layer(s) is preferably cereal-based and can be made from any suitable flours including one or more of rice flour, wheat bran, oat flour, white wheat flour, or maize grits.

Other potential ingredients for the shell or layer(s) include: sugar, maltodextrin, protein (soy, milk or other) and milk powder, minerals, oils, lecithin, etc.

Depending upon the desired taste of the nutrition product, it is preferred that the shell/layer(s) include no greater than 20% wt sugar solids based on the total weight of the shell/layer(s).

Where the product format allows, it is preferred that the nutrition product is produced by co-extrusion of the various regions of the product.

### The Filling, Coating or Topping

The filling, coating (including a decoration) or topping is preferably a fat based “cream” containing little or no water. Preferably, the filling, coating or topping includes no more than 5 wt % water, preferably no more than 1 wt % water.

### Optional Ingredients in Both Regions

The nutrition products of the invention may comprise further optional ingredients in any, or all, regions of the product such as in the filling, coating or topping and/or the shell or layers where these are present.

The nutrition product of the invention may include protein sources either in the first or second region or both. Preferred sources of protein include sources of diary protein such as whole milk, skim milk and skimmed milk powder, buttermilk, condensed milk, evaporated milk, milk solids non-fat, etc. The dairy source may contribute dairy fat and/or non-fat milk solids such as lactose and milk proteins, e.g. the whey proteins and caseins including whey protein isolate and whey protein concentrate, sources of protein from pulse sources such as pea protein, and sources of cereal protein such as wheat, or rice protein such as rice flour and rice protein concentrate. Soy protein may also be used. Of the above types, dairy proteins and pulse proteins are most preferred.

Protein concentrates may be used such as one or more of whey protein concentrate as mentioned above, milk protein concentrate, caseinates such as sodium and/or calcium caseinate, isolated soy protein and soy protein concentrate.

Total protein levels within the nutrition products of the invention are preferably within the range of 2.5 wt. % to 40 wt. %, such as from 10 wt. % to 30 wt. %, based on the total weight of the product. Total protein levels within the filling, coating or topping of the invention are preferably within the range of 5 wt. % to 60 wt. %, such as from 20 wt. % to 50 wt.%, based on the total weight of the filling.

It is preferred that 90 wt % of the protein used in the product or in a region is dairy protein.

It is preferred that the protein or protein mix used is of good quality as defined by the PDCAAS score (Protein digestibility Corrected Amino Acid Score which is fully understood by those skilled in the art and so does not to be defined further here) of 0.6 or greater, better is 0.7 or greater, such as 0.8 or greater, especially 0.9 or greater.

The products, especially the fillings, coatings or toppings may include emulsifying agents, typical of which are phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. The emulsifiers may be present at levels overall of about 0.03% to 1 wt %, preferably 0.05% to 0.7%, based on the weight of the products or fillings, coatings or topping wherever it is used. If it is used only in the filing, coating or topping then the weight of this region only is taken into account in calculating the weight percentages. Emulsifiers may be used in combination, as appropriate.

The products of the invention may include a filling agent. This may be used in the product as a whole or in a single region of the product. The filling agent preferably includes a fibre, particularly an at least partially digestible fibre such as dextrin. It is preferred that the fibrous filling agent is stable to typical food processing conditions, e.g., it does not hydrolyze to a substantial degree to increase the sugar content, and therefore, the sweetness, of the filler and ultimately of the product. Preferably, the fibrous component(s) of the thickening agent is well tolerated by the human digestive system and is water-soluble. The water solubility facilitates processing in manufacture of the snack foods. Fibres are useful in that they may also have favourable effects on blood sugar and on beneficial micro-organisms in the intestines. Nutriose® FB, available from Roquette Freres of Lestrem, France, is a preferred dextrin. The filling agents may be used in any suitable amounts, such as from 1 to 20% wt, preferably 1 to 10% wt.

Depending upon whether it is desired to have an overall sweet or savoury taste for the nutrition product, natural sources of sweetness may be included therein including sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Even if a savoury product is desired, natural sweeteners may be included in suitable amounts. Mono and disaccharide solids are typically present in the product at from 2-20 wt %, especially 0.1-10 wt %, especially 0.5-5 wt %.

If it is desired to use artificial sweeteners, any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners are typically used in varying amounts of about 0.005% to 1 wt. % on the product, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%, although lesser amounts may be dictated where it is desired to minimize sweetness.

If the nutrition product is a savoury product wherein sweetness does not predominate, it is preferred that the product contains essentially no artificial sweeteners. “Essentially no artificial sweeteners” herein refers to that level of sweetener which does not contribute perceptible sweetness to the taste of the product. It will be recognized that this level will differ from sweetener to sweetener, particularly since certain high intensity sweeteners can impart a sensation of sweetness at very low levels.

Carbohydrates can be used in the products of the invention at levels of from 0 to 90%, especially from 1% to 49%. As indicated above, sugars will be minimized or eliminated if the object is a savoury snack, which is not sweet. Likewise, other sweet-tasting carbohydrates will also preferably be minimized or eliminated. Apart from sweeteners, the fibres and the carbohydrate bulking agents mentioned above, examples of suitable carbohydrates include starches such as are contained in rice flour, flour, peanut flour, tapioca flour, tapioca starch, and whole wheat flour and mixtures thereof. The levels of carbohydrates in the snack of the invention as a whole will typically comprise from 5 wt. % to 90 wt. %, especially from 20% to 65 wt. %.

If it is desired to include a bulking agent in the nutrition product, a preferred bulking agent is inert polydextrose. Polydextrose may be obtained under the brand name Litesse. Other conventional bulking agents which may be used alone or in combination include maltodextrin, sugar alcohols, corn syrup solids, sugars or starches, subject to the desire to provide an overall sweet or savoury taste.

If desired, the nutrition products may include processing aids such as calcium chloride and/or magnesium carbonate.

Carrageenan may be included in the nutrition products of the invention, e.g., as a thickening and/or stabilizing agent (0 to 2 wt. % on product, especially 0.2 to 1%). Cellulose gel and pectin are other thickeners which may be used alone or in combination, e.g., at 0 to 10 wt. %, especially from 0.5 to 2 wt.

Calcium may be present in the nutrition products at from 0 to 100% of RDA, preferably from 10 to 30% RDA, especially about 25% RDA. The calcium source is preferably dicalcium phosphate, calcium carbonate or calcium lactate. For example, wt. % levels of dicalcium phosphate may range from 0.5 to 1.5%.

In a preferred embodiment, the nutrition product is fortified with one or more vitamins and/or additional minerals to those minerals which form an essential part of the invention and which are mentioned hereinabove and/or fibre sources in addition to the calcium source. These may include any or all of the following: Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), The vitamins and minerals are preferably present at from 5 to 100% RDA, especially 5 to 50% RDA, most especially from 15 to 35% RDA.

Flavourings are preferably added to the nutrition products in conventional amounts. The flavourings added may be chosen according to whether a sweet or savoury taste for the product is desired and the flavouring may be any of the commercial flavours employed in nutrition products, such as varying types of cocoa, pure vanilla or artificial flavour, such as vanillin, ethyl vanillin, chocolate, malt, mint, yogurt powder, extracts, spices, such as cinnamon, nutmeg and ginger, mixtures thereof, and the like. It will be appreciated that many flavour variations may be obtained by combinations of the basic flavours. Suitable flavourants may also include seasoning, such as salt (sodium chloride) or potassium chloride. Flavourings which help to mask off-tastes e.g. from vitamins and/or minerals and other ingredients may be included in the products of the invention. Preferably, flavourants are present at from 0.25 to 3 wt. % of the food, excluding salt or potassium chloride, which is generally present at from 0 to 1.5%, especially 0.1 to 1% wt.

The nutrition products of the invention may include colorants. Colorants are generally in the products in amounts of from 0 to 2 wt. %, especially from 0.1 to 1%.

### Caloric Values

Although the caloric balance of the nutrition products of the invention depends in part on the exact format of the product, in general, the products of the invention will have from 10 to 44% calories from fat, from 30 to 60% calories from carbohydrates and from 5 to 35% calories from protein, based on the total calories in the product. It is also preferred that the nutrition products of the invention comprise from 0 to 20%, especially 0.5 to 15%, calories from sugar solids, based on total calories in the product.

Preparation of the Nutrition Products and their Regions

The nutrition products of the invention may be made by suitable known methods dependent upon the format of the product. Ingredients are added to the products at a convenient time in the processing, provided that any temperature sensitive ingredients are not exposed to temperatures which cause degradation of their components.

Where the product format allows, it is preferred that they are produced by extrusion methods, preferably by co-extrusion. However, the products may also advantageously be produced as individual pieces, e.g. by baking, depending upon the format of the product. In this case, a layer or shell could be produced and a filling, topping and/or coating added thereafter.

Where a filling, coating or topping is used it may be produced by mixing most of the ingredients, refining e.g. by a five roll refiner and mixing again with some additional fat and adding the emulsifier e.g. lecithin and the chosen flavor. The filling, coating or topping is preferably refined to produce particle sizes in the range of 15-50, preferably 15-35, microns and a smooth mouth feel.

Where a shell or a layer is used it may be produced by a cook extruder supplied with the ingredients and a small quantity of water. The filling is fed into the extruder (at the die) in parallel to the shell or layer ingredients, so that a co extruded expanded product emerges from the die. The string of successive product may be cut e.g. to pillow shape or bar shape by a crimper, and the items are further dried. Then, optionally more flavours or decoration is added atop the product by application of flavoured starch or gum (or a mix of them), followed by tumbling and heat application to gelatinize the mix on the snacks. Then the product is packed.

The invention also concerns a process of making the nutrition product as according to the second aspect of the invention.

In a preferred embodiment of the second aspect, the nutrition product is prepared by co-extruding;
I) a first region which is an inner creamy filling or a coating or topping, and
II) a second region which is a shell or layer(s).

The invention will be further illustrated by reference to the following examples. Further examples within the scope of the invention will be apparent to the person skilled in the art. It should be understood of course that the specific forms of the invention herein illustrated and described are intended to be representative only, as certain changes may be made therein without departing from the clear teaching of the disclosure. Accordingly, reference should be made to the appended claims in determining the full scope.

### EXAMPLES

### Example 1

### A Sweet Bar with Filling

A sweet flavoured bar according to the present invention is given below. The bar consists of a filling as given in Table 1 surrounded by a shell as given in Table 2.

TABLE 1
FILLING FORMULATION

| Ingredient | % wt |
|---|---|
| Skimmed Milk Powder | 24.12 |
| Fruit powder | 8.61 |
| Fruit aroma | 0.19 |
| Sugar | 33.59 |
| Soy oil | 32.54 |
| Soy Lecithin | 0.48 |
| DHA algae oil | 0.47 |
| TOTAL | 100 |

TABLE 2
SHELL FORMULATION

| Ingredient | % wt |
|---|---|
| Wheat Bran | 2.32 |
| White Wheat Flour | 44.44 |
| Maize Grits | 2.73 |
| Sugar | 15.35 |
| Maltodextrin | 20.81 |
| Soy concentrate | 9.09 |
| Salt | 1.52 |
| Cocoa powder | 3.03 |
| Magnesium carbonate | 0.48 |
| Iron fumarate | 0.13 |
| Zinc sulphate•7H20 | 0.10 |
| TOTAL | 100 |

The bar comprises the filing and shell in a weight percentages of 48% wt and 52% wt respectively based on the weight of the total product.

The bars may be produced by the following method;

The filling may be produced by mixing most of the ingredients, refining e.g. by a five roll refiner and mixing again with some additional fat and adding the lecithin and the chosen flavor. The filling is preferably refined to produce particle sizes in the range of 15-50, preferably 15-35, microns and a smooth, creamy mouth feel. The shell may be produced by a cook extruder supplied with the ingredients and a small-quantity of water. The filling is fed into the extruder (at the die) in parallel to the shell ingredients, so that a co extruded expanded product emerges from the die. The string of successive product may be cut to pillow shape by a crimper, and the items are further dried. Then, optionally more seasoning is added atop the product by application of flavoured starch or gum (or a mix of them), followed by tumbling and heat application to gelatinize the mix on the snacks. Than the product is packed.

Optionally a decoration can be added to the bar by using an edible adhesive which is added to the bar. Decorations of the chosen type can then be added on top of the glue and the bars heated for a few minutes, e.g. in an oven or microwave to set the adhesive.

The bars were evaluated for taste and stability by storing them under various conditions for at least 3 months. The conditions were chilled (10° C.) ambient (20° C.), warm (30° C.) and hot (37° C.). Before and after 1, 2 and 3 months samples ware taken and tasted in a panel. The panel scored on flavour and off-flavour. After three months the panel results were still positive and no off flavours were detected in the bars of the invention. This indicates good stability of the products. As a control, products were produced having the DHA and the metal salts in the same region of the bar. These control samples produced off-flavours under the test storage conditions.

### Example 2

### A Savoury Bar with Filling

A savoury flavoured bar according to the present invention is given below. The bar consists of a filling as given in Table 3 surrounded by a shell as given in Table 4.

TABLE 3
FILLING FORMULATION

| Ingredient | % wt |
|---|---|
| Skimmed Milk Powder | 25.20 |
| Soy concentrate | 10.00 |
| Maltodextrin | 26.30 |
| Salt | 0.70 |
| Soy oil | 33.50 |
| Savoury powders | 3.30 |
| Soy Lecithin | 0.50 |
| DHA algae oil | 0.50 |
| TOTAL | 100 |

TABLE 4
SHELL FORMULATION

| Ingredient | % wt |
|---|---|
| Wheat Bran | 3.50 |
| White Wheat Flour | 65.70 |
| Maize Grits | 5.00 |
| Maltodextrin | 20.60 |
| Salt | 1.19 |
| Cheese powder | 3.03 |
| Magnesium carbonate | 0.48 |
| Iron fumarate | 0.13 |
| Zinc sulphate•7H20 | 0.10 |
| TOTAL | 100 |

The bar comprises the filing and shell in a weight percentages of 46% wt and 54% wt respectively based on the weight of the total product.

The bars may be produced following the same method as for example 1. The storage stability results were the same as for the bars of example 1.

### Example 3

### A Sweet Bar with Filling

A sweet flavoured bar according to the present invention is given below. The bar consists of a filling as given in Table 5 surrounded by a shell as given in Table 6.

TABLE 5
FILLING FORMULATION

| Ingredient | % wt |
|---|---|
| Skimmed Milk Powder | 24.91 |
| Malitol | 8.80 |
| Banana powder | 8.90 |
| Fruit aroma | 0.20 |
| Sugar | 25.90 |
| Oil blend of 15% wt | 25.74 |
| linseed oil and | |
| 85% wt sunflower oil | |
| Soy Lecithin | 0.49 |
| Hazelnut mass | 12.87 |
| TOTAL | 100 |

TABLE 6
SHELL FORMULATION

| Ingredient | % wt |
|---|---|
| Wheat Bran | 2.32 |
| White Wheat Flour | 44.44 |
| Maize Grits | 2.73 |
| Sugar | 15.35 |
| Maltodextrin | 20.81 |
| Soy concentrate | 9.09 |
| Salt | 1.52 |
| Magnesium carbonate | 0.48 |
| Iron fumarate | 0.13 |
| Zinc sulphate•7H20 | 0.10 |
| Cocoa powder | 3.03 |
| TOTAL | 100 |

The bar comprises the filing and shell in a weight percentages of 48% wt and 52% wt respectively based on the weight of the total product.

The bars may be produced following the same method as for example 1. The storage stability results were the same as for the bars of example 1.

### Example 4

### A Sweet Bar with Decoration

A sweet flavoured bar according to the present invention is given below. The bar consists of a filling as given in Table 7 surrounded by a shell as given in Table 8 and comprising the oxidising materials in the decoration given in Table 9.

TABLE 7
FILLING FORMULATION

| Ingredient | % wt |
|---|---|
| Skimmed Milk Powder | 24.12 |
| Fruit powder | 8.61 |
| Fruit aroma | 0.19 |
| Sugar | 33.59 |
| Soy oil | 32.54 |
| Soy Lecithin | 0.48 |
| DHA algae oil | 0.47 |
| TOTAL | 100 |

TABLE 8
SHELL FORMULATION

| Ingredient | % wt |
|---|---|
| Wheat Bran | 2.32 |
| White Wheat Flour | 44.44 |
| Maize Grits | 2.73 |
| Sugar | 15.35 |
| Maltodextrin | 20.81 |
| Soy concentrate | 9.09 |
| Salt | 1.01 |
| Cocoa powder | 3.03 |
| Flavours | 1.21 |
| TOTAL | 100 |

TABLE 9
DECORATION FORMULATION

| Ingredient | % wt |
|---|---|
| Iron fumarate | 3.3 |
| Zinc sulphate•7H20 | 2.0 |
| Dry Tac powder (ex | 49.7 |
| National Starch) | |
| Water | 21.3 |
| Sugar balls | 23.7 |
| TOTAL | 100 |

The bar comprises the filing and shell in a weight percentages of 48% wt and 52% wt respectively based on the weight of the shell and filing. About 2.5% wt of decoration was added based on the weight of the filing and shell

The bars may be produced by the method given for example 1.

The decoration can be added to the bar by using an edible adhesive which is added to the bar. Decorations of the chosen type can then be added on top of the glue and the bars heated for a few minutes, e.g. in an oven or microwave to set the adhesive.

The storage stability results were the same as for the bars of example 1.

1. A nutrition product comprising;
a) a first region comprising at least 10% by weight of said first region of one or more oxidisable materials containing monounsaturated and/or polyunsaturated fatty acids, and
b) a second region comprising 0.002% to 1.0% by weight of said second region of one or more oxidising materials selected from chromium, manganese, iron, cobalt, nickel, copper, selenium and zinc
and wherein the oxidisable materials and the oxidising materials in the nutrition product are comprised in different regions of the product.

2. A nutrition product according to claim 1, wherein the product comprises;
a) a shell containing a filling,
b) two or more individual layers with or without a filling therebetween, or
c) one or more layers with a topping or coating.

3. A nutrition product according to claim 1, wherein the product is produced by co-extrusion.

4. A nutrition product according to claim 1, wherein the polyunsaturated fatty acids are selected from omega 3 and omega 6 fatty acids.

5. A nutrition product according to claim 4, wherein the polyunsaturated fatty acids are selected from arachidonic acid, docosahexaenoic acid, eicosapentaenoic acid, lineoleic acid, linolenic acid (alpha linolenic acid) and gamma-linolenic acid.

6. A nutrition product according to claim 1, wherein the oxidisable materials are present in the product in an amount of from 10-25% wt based on the total weight of the product.

7. A nutrition product according to claim 1, wherein the oxidisable materials are present in the first region of the product in an amount of from 20 to 50% wt based on the total weight of the first region.

8. A nutrition product according to claim 1, wherein first region of the product is a filling, coating or topping.

9. A nutrition product according to claim 1, wherein the oxidising materials comprise metals capable of having two or more different oxidation states.

10. A nutrition product according to claim 1, wherein the metals are selected from iron and zinc.

11. A nutrition product according to claim 1, wherein the oxidising materials are present in the product in an amount of from 0.001 to 0.5% wt based on the total weight of the product.

12. A nutrition product according to claim 1, wherein the oxidising materials are present in the second region of the product in an amount of from 0.01 to 0.3% wt based on the total weight of the second region.

13. A nutrition product according to claim 1, wherein second region of the product is a shell or layer(s).

14. A nutrition product according to claim 1, wherein the polyunsaturated fatty acid is selected from arachidonic acid, docosahexaenoic acid, eicosapentaenoic acid, lineoleic acid, linolenic acid (alpha linolenic acid) and gamma-linolenic acid and the transition metal is selected from iron and zinc.

15. A nutrition product according to claim 1, wherein the product comprises 20 to 80% wt of the first region comprising the oxidisable material and 80 to 20% wt of the second region comprising the oxidising material based on the total weight of the product.

16. A nutrition product according to claim 15, wherein the product comprises 40 to 60% wt of the first region and 60 to 40% wt of the second region, based on the total weight of the product.

17. A nutrition product according to claim 1, wherein the product further comprises protein.

18. A nutrition product according to claim 17, wherein the product further comprises dairy proteins and/or pulse proteins.

19. A nutrition product according to claim 17, wherein the product further comprises 2.5 wt. % to 40 wt. %, protein based on the total weight of the product or 5 wt. % to 60 wt. based on the total weight of the first region.

20. A process of making a nutrition product, by forming the nutrition product from;
I) a first region comprising at least 10% by weight of said first region of one or more oxidisable materials containing monounsaturated and/or polyunsaturated fatty acids, and
II) a second region comprising 0.002% to 1.0% by weight of said second region of one or more oxidising materials selected from chromium, manganese, iron, cobalt, nickel, copper selenium and zinc,
and wherein the oxidisable materials and the oxidising materials in the nutrition product are comprised in different regions of the product.

21. A process according to claim 20, wherein the nutrition product is prepared by co-extruding;
I) a first region which is an inner creamy filling or a coating or topping, and
II) a second region which is a shell or layer(s).
